(19) United States
(12) Patent Application Publication
(10) Pub. No.: US 2013/0179107 A1
(43) Pub. Date: Jul. 11, 2013

(54) MOVING STAGE ESTIMATION APPARATUS, METHOD AND PROGRAM

(71) Applicants: Hisao SETOGUCHI, Kawasaki-shi (JP); Naoki IKETANI, Kawasaki-shi (JP); Kenta CHO, Tokyo (JP); Masanori HATTORI, Kawasaki-shi (JP)

(72) Inventors: Hisao SETOGUCHI, Kawasaki-shi (JP); Naoki IKETANI, Kawasaki-shi (JP); Kenta CHO, Tokyo (JP); Masanori HATTORI, Kawasaki-shi (JP)

(73) Assignee: KABUSHIKI KAISHA TOSHIBA, Tokyo (JP)

(21) Appl. No.: 13/542,112

(22) Filed: Jul. 5, 2012

Related U.S. Application Data
(63) Continuation of application No. PCT/JP2010/050086, filed on Jan. 7, 2010.

(51) Int. Cl. G01C 25/00

(52) U.S. Cl. CPC G01C 25/005
USPC 702/94

(57) ABSTRACT

According to one embodiment, a moving state estimation apparatus includes a sensor, a storage, a first estimation unit, a second estimation unit, a calculation unit and a correction unit. The sensor detects acceleration data. The first estimation unit estimates certainty degrees of the moving states. The second estimation unit calculates orientations of the terminal based on the acceleration data, and to estimate terminal states. The calculation unit calculates reliability degrees of the moving states. The correction unit corrects the certainty degrees in accordance with the reliability degrees, to obtain corrected moving states with the certainty degrees corrected.

### CROSS REFERENCE TO RELATED APPLICATIONS

This application is a Continuation Application of PCT Application No. PCT/JP2010/050086, filed Jan. 7, 2010, the entire contents of which are incorporated herein by reference.

### FIELD

Embodiments described herein relate generally to a moving state estimation apparatus, method and program.

### BACKGROUND

There are conventional devices for estimating the moving states (such as a stationary state, a walking state, and a boarding state in a bus or train) of a user, utilizing an acceleration sensor included in a mobile phone terminal. Further, there are some conventional techniques of reducing estimation errors associated with the moving states (See, e.g., JP-A No. 2005-286809 (KOKAI)). For example, one technique discloses a method of reducing estimation errors by interrupting user moving state estimation when, for example, the state of use of a mobile terminal, such as an incoming state or an email sending/receiving state, is detected. Another technique discloses a method of reducing estimation errors by combining user position information based on the global positioning system

(GPS), and map information (See, e.g., JP-A No. 2007-303989 (KOKAI)).

### BRIEF DESCRIPTION OF THE DRAWINGS

FIG. 1 is a block diagram illustrating a moving state estimation apparatus according to a first embodiment;

FIG. 2 is a view explaining definition examples of moving states;

FIG. 3 is a view explaining definition examples of terminal states;

FIG. 4 is a flowchart illustrating the operation of the moving state estimation apparatus;

FIG. 5 is a flowchart illustrating the operation of a moving state estimation unit;

FIG. 6 is a view illustrating examples of certainty degrees corresponding to the moving states output from the moving state estimation unit;

FIG. 7 is a view explaining examples of detection criteria for terminal states;

FIG. 8 is a flowchart illustrating the operation of a terminal state estimation unit;

FIG. 9 is a view illustrating an example of a reliability calculation model stored in a reliability calculation model storage;

FIG. 10 is a view illustrating estimation result examples of the moving states output from a certainty degree correction unit;

FIG. 11 is a block diagram illustrating a moving state estimation apparatus according to a second embodiment;

FIG. 12 is a view illustrating a screen example displayed on a display;

FIG. 13 is a view illustrating an example of a reliability calculation model updated after receiving an input signal;

FIG. 14 is a block diagram illustrating a moving state estimation apparatus according to a third embodiment; and

FIG. 15 is a view illustrating a relationship example between moving states and changes in direction.

### DETAILED DESCRIPTION

There is a case where the moving state of a user is needed to be estimated even when, for example, they are making a phone call or sending/receiving an email. In this case, it is not preferable to the user to interrupt the estimation of the moving state. In addition to the vibration that may occur when the user uses their mobile terminal upon receiving an incoming call or sending/receiving an email, there exist other factors of adversely affecting the estimation accuracy of the user moving state, such as vibration of the user hands during holding the terminal, and the acceleration exerted on the terminal when the user takes the terminal out of, for example, a bag. Therefore, if only the state of use of the terminal is taken into consideration, the estimation error of the user moving state will become greater.

In addition, at a place (such as the subway or an underground shopping area) where the global positioning system (GPS) cannot be accessed, accurate user position information and map information cannot be referred to, whereby the estimation error of the moving state will become greater.

In general, according to one embodiment, a moving state estimation apparatus includes a sensor, a storage, a first estimation unit, a second estimation unit, a calculation unit and a correction unit. The sensor configured to detect three-axis acceleration of a terminal as acceleration data. The storage is configured to store a moving state estimation model including moving states of a user of the terminal. The first estimation unit is configured to estimate certainty degrees of the moving states based on the acceleration data and the moving state estimation model, the certainty degrees indicating degrees of certainty with which the user may be in the respective moving states. The second estimation unit is configured to calculate orientations of the terminal based on the acceleration data, and to estimate terminal states indicating states of the terminal, based on the orientations of the terminal and the acceleration data. The calculation unit is configured to calculate reliability degrees of the moving states, the reliability degrees indicating degrees with which combinations of the moving states and the terminal states coincide with a combination of an actual moving state of the user and an actual terminal state of the terminal. The correction unit is configured to correct the certainty degrees in accordance with the reliability degrees, to obtain corrected moving states with the certainty degrees corrected.

Moving state estimation apparatuses, methods and programs according to embodiments will be described in detail with reference to the accompanying drawings. In the embodiments, like reference numbers denote like elements, and duplicate of descriptions will be avoided.

Referring first to FIG. 1, a moving state estimation apparatus 100 according to a first embodiment will be described.

The moving state estimation apparatus 100 of the first embodiment includes an acceleration sensor 101, a moving state estimation model storage 102, a moving state estimation unit 103 (first estimation unit), a terminal state estimation unit 104 (second estimation unit), a reliability calculation model storage 105, a reliability calculation unit 106 and a certainty correction unit 107.

The acceleration sensor 101 measures an acceleration that occurs when a user moves, and obtains the measured acceleration as acceleration data. The acceleration sensor 101 is designed to measure acceleration using three or more directional axes. The acceleration sensor is assumed to be a small sensor of a micro electro mechanical system (MEMS), but is not limited to it. It is sufficient if the sensor can measure acceleration.

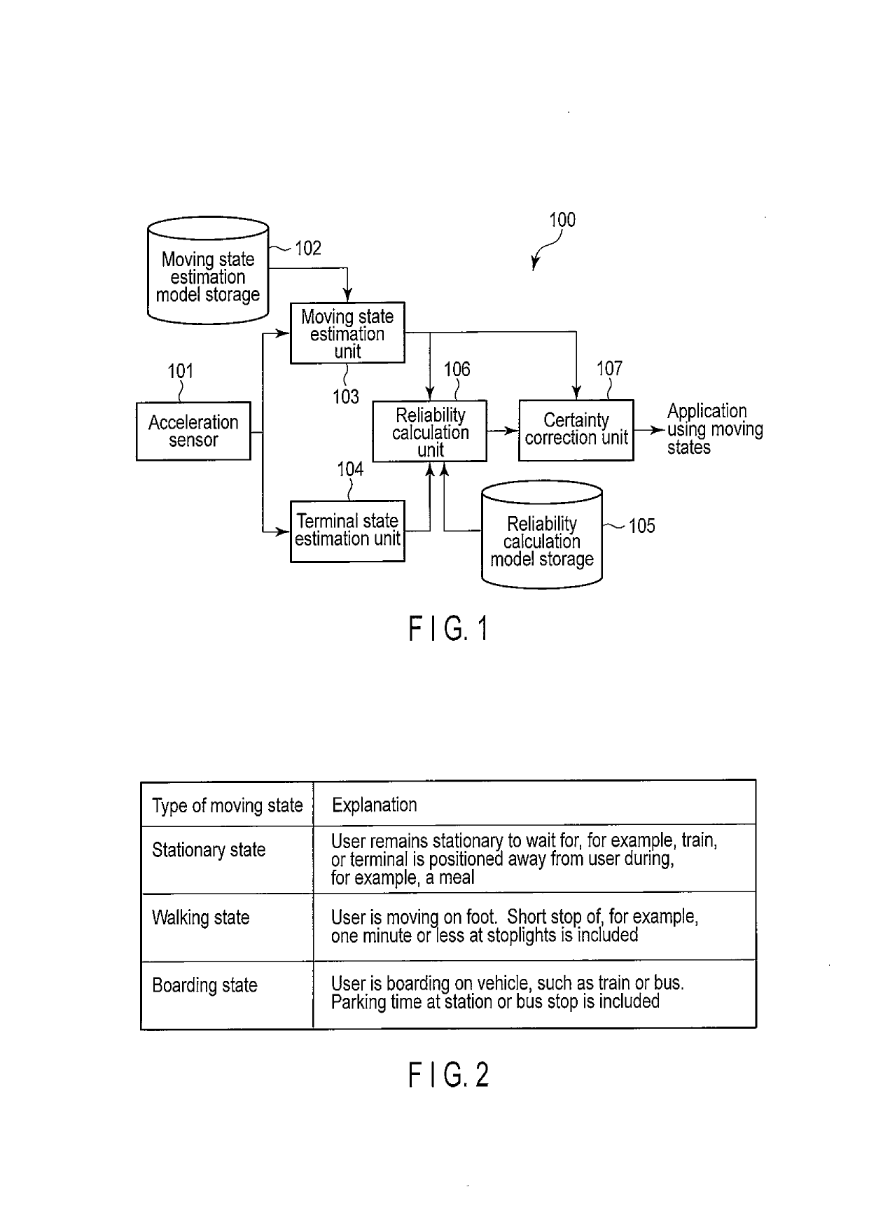

The moving state estimation model storage 102 stores a moving state estimation model. As the moving state estimation model, a neural network is stored in which learning is beforehand performed using data on the relationship between the acceleration data acquired from the acceleration sensor 101 and the moving state of a user. The moving state indicates a state in which the user remains stationary, or indicates the moving means when the user is moving. The moving state will be described later with reference to FIG. 2.

Although the first embodiment employs a neural network as the moving state estimation model, the embodiment is not limited to this. For instance, the embodiment may be modified to a pattern matching scheme where a table showing the relationship between the occurrence pattern of acceleration and the moving state is prepared, and pattern matching is performed using this table and the acquired acceleration data, or modified to a classification scheme using Hidden Markov Model (HMM).

The moving state estimation unit 103 acquires the acceleration data and the moving state estimation model from the acceleration sensor 101 and the moving state estimation model storage 102, respectively, and estimates moving states and degrees of certainty (hereinafter certainty degree) corresponding to the respective moving states, referring to the moving state estimation model. The certainty degree means the degree of possibility at which the user is in a given moving state. The operation of the moving state estimation unit 103 will be described later with reference to FIG. 5.

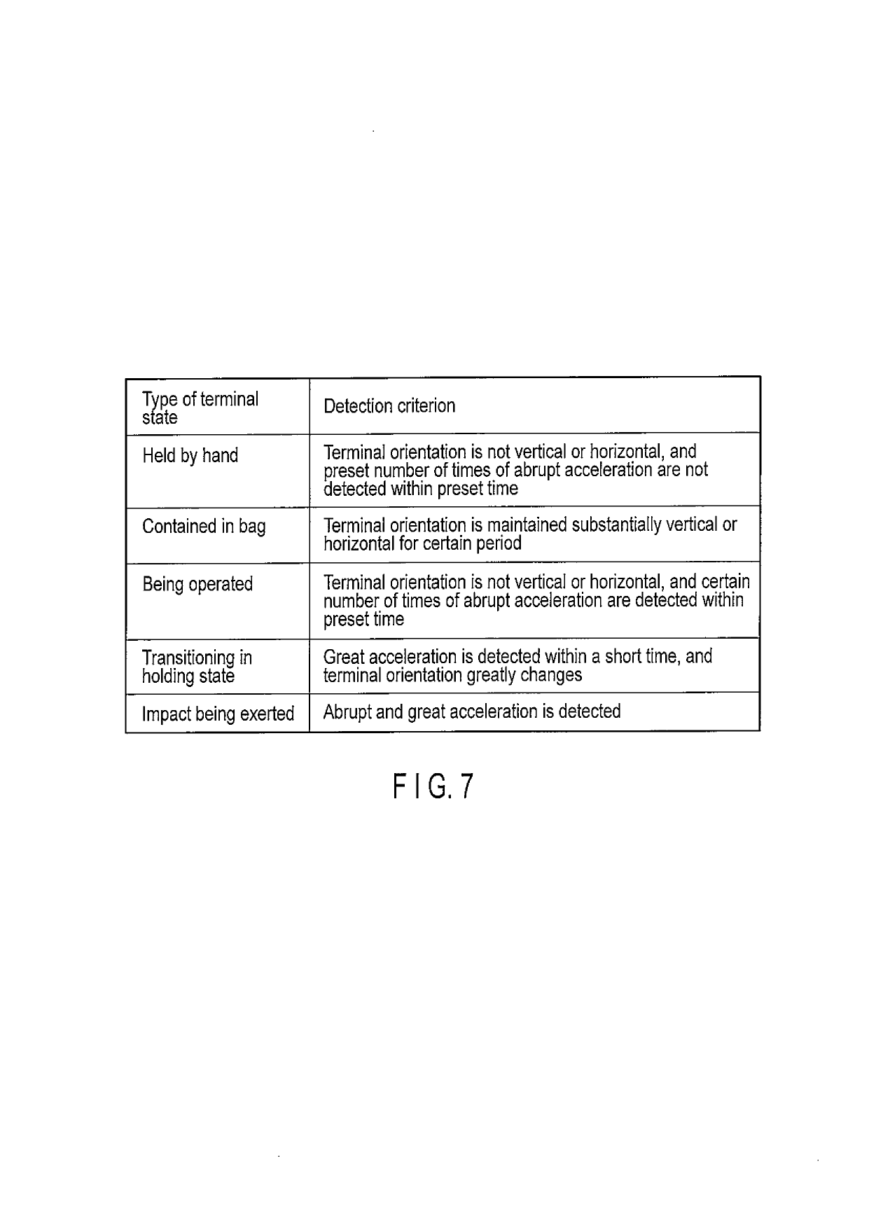

The terminal state estimation unit 104 acquires the acceleration data from the acceleration sensor 101 and estimates the states of a terminal using the acceleration data. The terminal state indicates a state that the terminal may assume, and for example, includes a state in which the user holds the terminal, a state in which the user uses the terminal, etc. The operation of the terminal state estimation unit 104 will be described later with reference to FIG. 7.

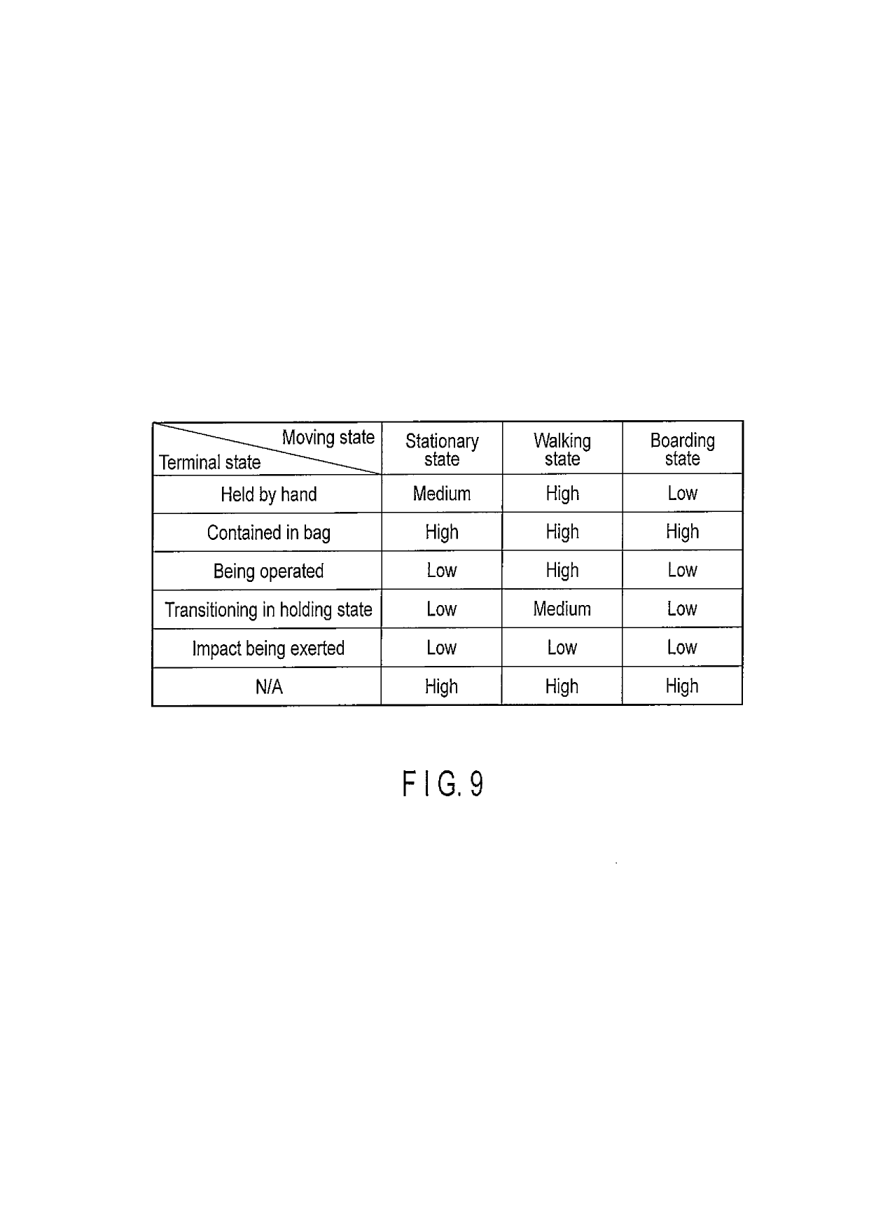

The reliability calculation model storage 105 stores, as a reliability calculation model, a table showing degrees of reliability (hereinafter reliability degree) set for the respective combinations of the moving states and the terminal states. The reliability degree indicates the possibility of coincidence of the combination of a moving state and a terminal state with the combination of the actual moving state of the user and the actual terminal state of the terminal. Here, the “actual” indicates that it has happened actually. That is, the actual moving state indicates a moving state which has happened actually, and the actual terminal state indicates a terminal state which has happened actually. More specifically, when the user is walking while seeing map information on the terminal, the actual moving state is “a walking state,” and the actual terminal state is “an operating state.” The reliability calculation mode will be described later with reference to FIG. 9.

The reliability calculation unit 106 acquires the moving states and the terminal states from the moving state estimation unit 103 and the terminal state estimation unit 104, respectively, and calculates the reliability degree of the combination of each moving state and each terminal state. The format of the reliability degree calculation model is not limited to a table. The reliability degree calculation model may be obtained using an arbitrary numerical expression.

The certainty correction unit 107 acquires the moving states and the reliability degrees from the moving state estimation unit 103 and the reliability calculation unit 106, respectively, and corrects the certainty degree of each moving state referring to the corresponding reliability degree. The moving state of the highest certainty degree among the certainty degree-corrected moving states is output as the moving state of the user at a certain time point to an external moving state utilizing application.

Instead of outputting the moving state of the highest certainty degree, an arbitrary number of moving states of higher certainty degrees, or moving states of certainty degrees not less than a predetermined threshold, or all moving states, may be output.

Referring then to FIG. 2, examples of moving states will be described in detail.

In the first embodiment, “stationary state,” “walking state” and “boarding state” are defined as moving states. However, the moving states are not limited to these states, but further moving states may be defined.

Specifically, the “stationary state” indicates a state in which the user remains stationary to, for example, wait for a train at a station, or in which the terminal is positioned away from the user during, for example, a meal. Further, the “walking state” and the “boarding state” are regarded as user moving states. The “walking state” is a state in which the user is walking, and includes a short stop of, for example, one minute or less at, for example, stoplights. The “boarding state” is a state in which the user is boarding in a vehicle, such as a train or bus, and includes a vehicle parked state at a station, a bus stop, etc. The short stop of one minute or less in the “walking state” or the short parking in the “boarding state” can be estimated as the “stationary state” in standard moving state estimation. However, in this embodiment, they are defined as the “walking state” or the “boarding state,” because such a short stop or parking is regarded as a series of actions of the user and should preferably be included in the “walking state” or the “boarding state.”

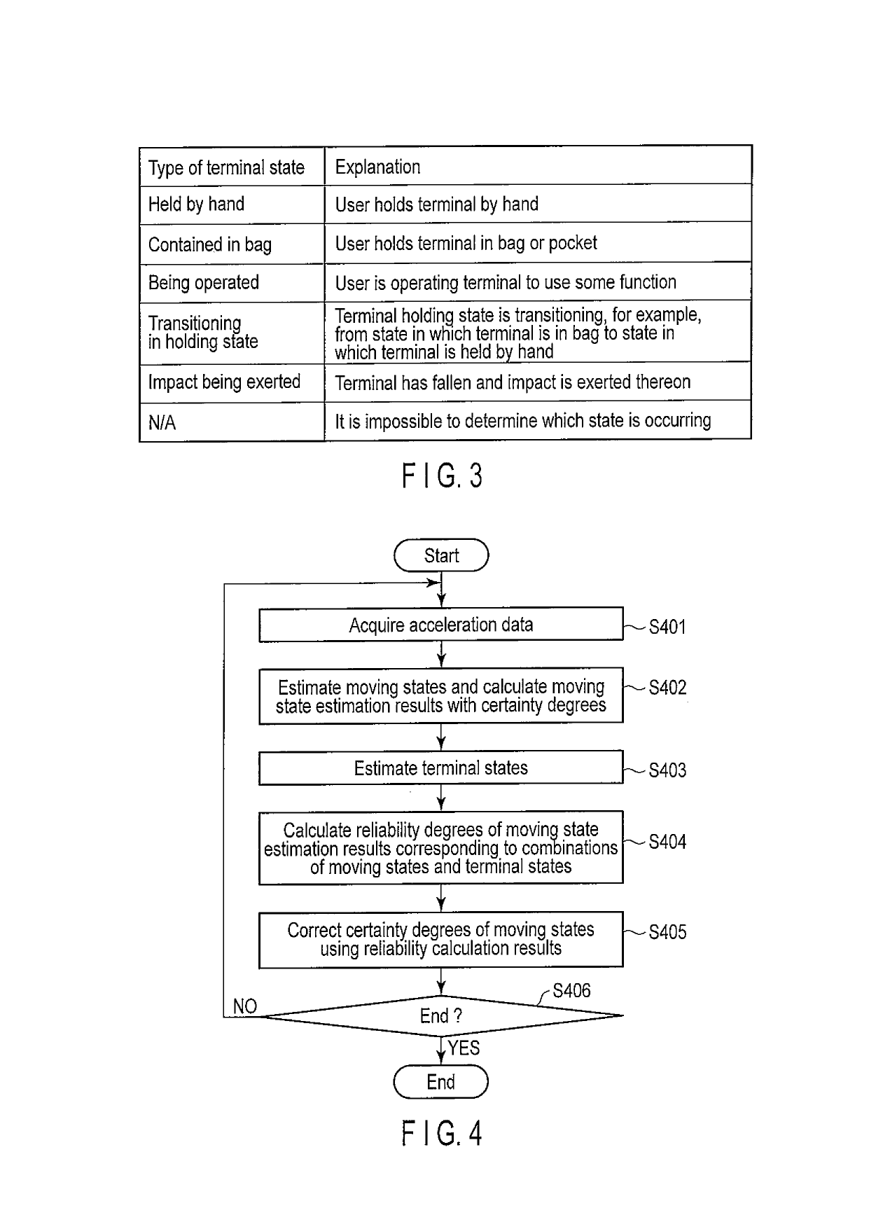

Referring to FIG. 3, a detailed description will be given of terminal state examples.

Although in the first embodiment, “Held by hand,” “Contained in bag,” “Being operated,” “Transitioning in holding state,” “Impact being exerted,” and “N/A” are defined as terminal states, other terminal states may be defined.

“Held by hand” indicates the user holds terminal by hand. “Contained in bag” indicates the user holds terminal in bag or pocket. “Being operated” indicates the user is operating terminal to use some function. “Transitioning in holding state” indicates terminal holding state is transitioning, for example, from state in which terminal is in bag to state in which terminal is held by hand. “Impact being exerted” indicates the terminal has fallen and impact is exerted thereon. “N/A” indicates determining which state is occurring is impossible.

Further, although in the first embodiment, it is assumed that the state of a terminal is estimated using the acceleration data from the acceleration sensor 101, it may be estimated using another type of sensor, such as an illuminance sensor. If the illuminance sensor is used, the terminal state estimation is performed utilizing a change in illuminance per unit time. For instance, when the illuminance detected by the illuminance sensor is high, it is determined that the terminal is held by the hand, while when the detected illuminance is low, the terminal is determined to be in a bag. Similarly, when the illuminance is detected to be monotonically increasing or decreasing, it is determined that the holding state of the terminal is transitioning.

Referring now to the flowchart of FIG. 4, a detailed description will be given of a moving state estimation process performed in the moving state estimation apparatus 100 of the first embodiment.

At step S401, the acceleration sensor 101 acquires acceleration data associated with the movement of a user. The interval at which the acceleration sensor 101 acquires the acceleration data is set so that the sensor can detect an abrupt acceleration, such as the acceleration of the terminal that will occur due to the impact exerted thereon when the terminal has fallen.

At step S402, the moving state estimation unit 103 refers to the acceleration data and the moving state estimation model, and estimates moving states and the degrees of certainty corresponding thereto.

At step S403, the terminal state estimation unit 104 estimates such terminal states as shown in FIG. 3, based on the acceleration data.

At step S404, the reliability calculation unit 106 calculates the degrees of reliability corresponding to all combinations of the estimated moving states and terminal states.

At step S405, the certainty correction unit 107 corrects the certainty degrees of the respective moving states based on the reliability degrees calculated by the reliability calculation unit 106, thereby obtaining a final moving state.

At step S406, it is determined whether there is an instruction to stop the moving state estimation from the user, or whether a preset period of time elapses (where the moving state estimation is designed to be automatically stopped if the preset period elapses). If there is the instruction or the preset period elapses, the moving state estimation process is finished. In contrast, if there is no instruction or the preset period does not elapse, the program returns to step S401, and steps S401 to S405 are iterated.

Referring then to the flowchart of FIG. 5, a detailed description will be given of the moving state estimation process performed at step S402 by the moving state estimation unit 103.

At step S501, acceleration data is received from the acceleration sensor 101.

At step S502, three-dimensional feature amounts F1(t), F2(t) and F3(t) are calculated based on the acceleration data.

When calculating the three-dimensional feature amounts F1(t), F2(t) and F3(t), a gravity vector is estimated firstly. Utilizing the fact that a gravity of 1 G is always exerted on the acceleration sensor, the average vector of the X-, Y- and Z-directional vectors in a preset time interval wG is estimated as the gravity vector. The gravity vector vG(t) at time point t is given by the following equation, using triaxial acceleration vector v(t):

$$v G ( t ) = \frac{{\sum }_{i = t - w G}^{t} v ( i )}{w G}$$

Subsequently, the gravity vector vG(t) is subtracted from the triaxial acceleration vector v(t) to obtain a normalized acceleration vector. An acceleration vector vn(t) normalized at the time point t is defined by the following equation:

vn(t)=v(t)−vG(t)

Using the normalized acceleration vector vn(t), the vector length of the normalized acceleration vector vn(t), the inner product of the normalized acceleration vector vn(t) and the gravity vector vG(t), and the outer product of the normalized acceleration vector vn(t) and the gravity vector vG(t) are calculated as the feature amounts F1(t), F2(t) and F3(t) at the time point t. Namely, the feature amounts F1(t), F2(t) and F3(t) are the three-dimensional feature amounts. The three-dimensional feature amounts are calculated to eliminate the influence, on a terminal, of the movement of a user. The feature amounts F1(t), F2(t) and F3(t) at the time point t are given by the following equations:

F1(t)=∥vn(t)∥

F2(t)=vn(t)·vG(t)

F3(t)=vn(t)×vG(t)

At step S503, the average value, the maximum value and three statistical values, i.e., the average value, the maximum value and the variance, within the preset time interval of wG from the time point t are calculated for each of the feature amounts F1(t), F2(t) and F3(t) that are calculated at step S502 and do not depend on the orientation of the terminal. Since thus, three statistical values are calculated for each feature amount, nine feature amounts are calculated in total. These nine feature amounts will hereinafter be referred to as nine-dimensional feature amounts.

The reason why the nine-dimensional feature amounts are calculated lies in that the normalized feature amount is an amount acquired in a moment that is much shorter than the period of a change in the behavior of a human, and therefore a feature including a variation tendency with time or variations within a preset period may not be detected. This being so, in order to acquire feature amounts effective in estimating the moving state, it is necessary to calculate basic statistical values within the preset time interval of wG from the present time. By virtue of the nine-dimensional feature amounts, the feature of the terminal state within the preset time interval of wG.

At step S504, the moving states are classified based on the nine-dimensional feature amounts, referring to the moving state estimation model stored in the moving state estimation model storage 102, whereby all moving states and the degrees of certainty corresponding thereto are calculated. In the first embodiment, the nine-dimensional feature amounts are input to the neural network to perform moving state classification. Since in the first embodiment, three moving states are defined, the neural network outputs all degrees of certainty ranging from 0 to 1 and corresponding to the three moving states. It should be noted that at any time point, the sum of the certainty degrees corresponding to the three moving states is an inconstant value that falls within a range of 0 to 3.

At step S505, the moving states calculated at step S504 are corrected using a transition probability model.

The reason why such correction is performed is that if the moving state is estimated simply from the behavior of the acceleration sensor, the moving state, assumed when, for example, a train or bus temporarily stops, or when walking temporarily stops, may well be estimated as the “stationary state.” To prevent such erroneous estimation, correction is performed so that the above train's or bus's temporary stop will be included in the “boarding state” and a temporary stop at stoplights will be included in the “walking state,” as is defined in the table of FIG. 2.

For instance, in general, walking is often performed immediately after dropping off from a vehicle. In this case, the output of the neural network is made to smoothly transition from the “boarding state” to the “walking state.” However, where the boarding state directly transitions to the stationary state, the output of the neural network is not immediately made to transition to the “stationary state,” but is made to transition to the “stationary state” for the first time when the stationary state continues several seconds. This process is an example of the correction. The degree of variability from a certain moving state to another moving state is corrected using the transition probability model.

At step S506, moving states of certainty degrees higher than a certain threshold associated with the certainty degrees' corresponding to the moving states corrected at step S505 are output. Alternatively, no threshold may be set, and the corrected moving states and the certainty degrees corresponding thereto be output to the certainty degree correction unit 107.

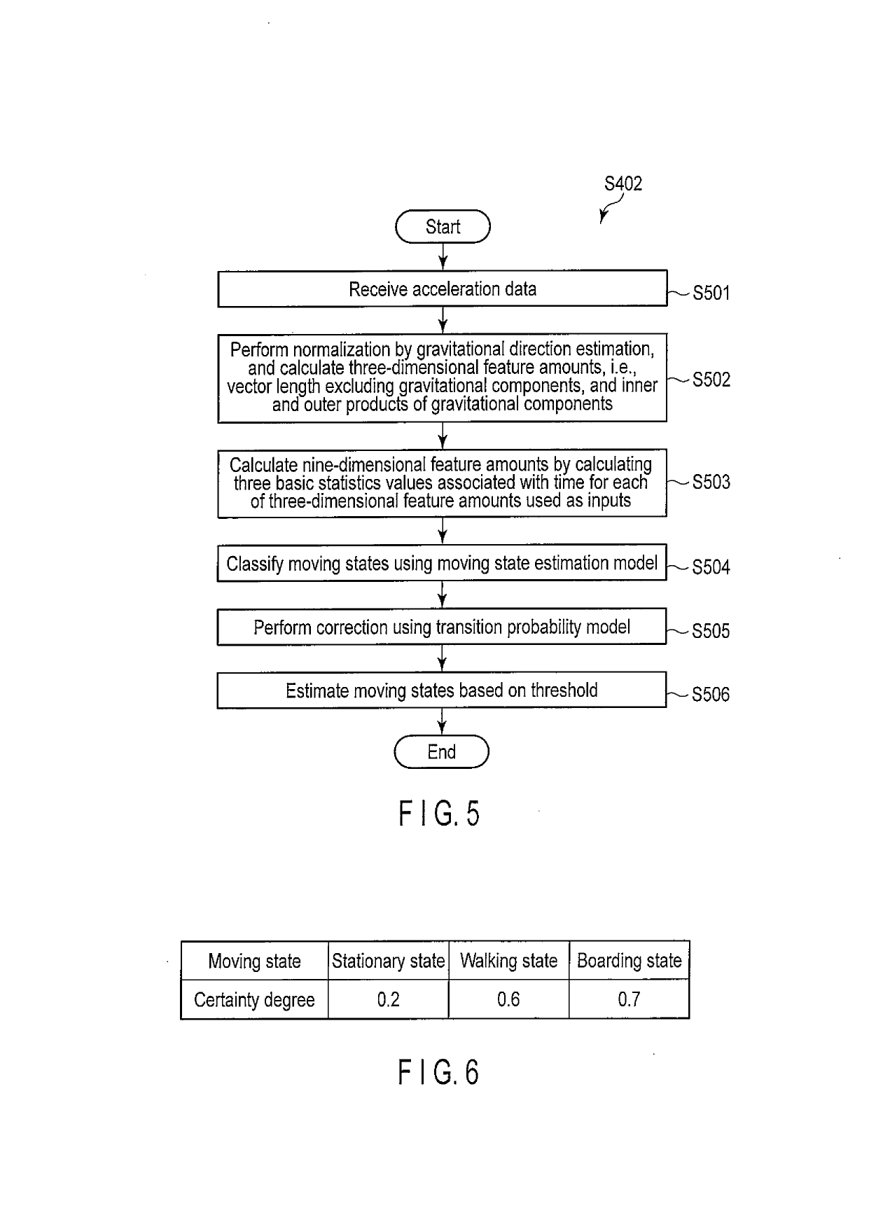

FIG. 6 shows examples of certainty degrees corresponding to the moving states corrected at step S505. As shown in FIG. 6, certainty degrees of “0.2,” “0.6” and “0.7” are associated with the three moving states of “stationary state,” “walking state” and “boarding state,” respectively.

The process at step S506 will now be described in detail, referring to the examples of FIG. 6. For instance, if the certainty degree threshold is set to “0.5,” the “walking state” and “boarding state,” included in the three moving states, have certainty degrees (“0.6” and “0.7,” respectively) higher than the threshold.

FIG. 7 shows detection criteria for terminal states used for the terminal state estimation process performed at step S403 by the terminal state estimation unit 104.

Terminal state estimation is performed, using the detection criteria based on acceleration data. More specifically, if the terminal state is the “Held by the hand,” it indicates, as the definition, the “state in which a user holds the terminal by the hand,” and indicates, as a detection criterion using the acceleration data, a “state in which the orientation of the terminal (also referred to as a “terminal orientation”) is not vertical or horizontal, and abrupt acceleration is not detected more than predetermined times within a predetermined period of time.” Thus, in the terminal state estimation process, terminal states can be estimated using the acceleration data.

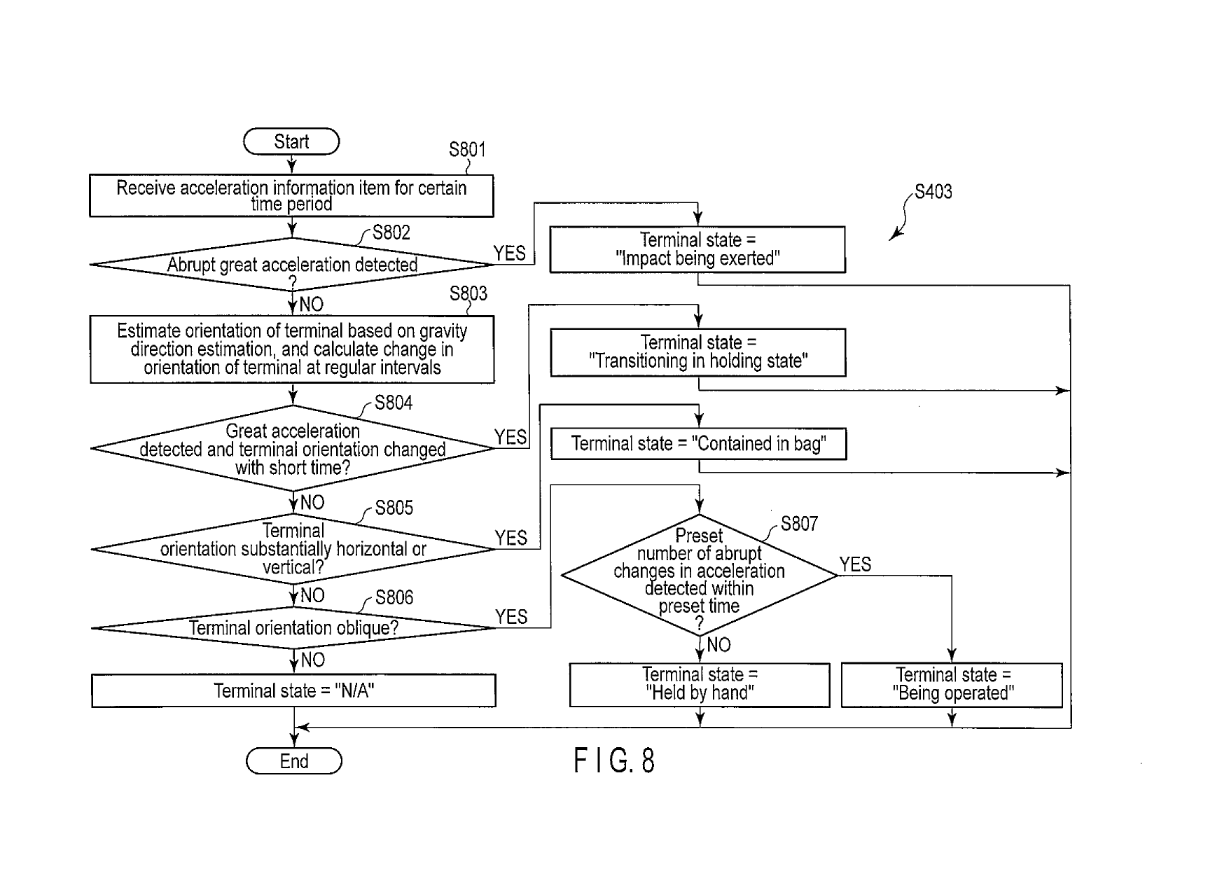

Referring then to the flowchart of FIG. 8, a detailed description will be given of the terminal state estimation process performed at step S403 by the terminal state estimation unit 104.

At step S801, after receiving acceleration data from the acceleration sensor 101, the terminal state estimation unit 104 performs normalization of the acceleration data, as in the moving state estimation unit 103.

At step S802, the terminal state estimation unit 104 determines whether abrupt acceleration is detected within a time interval wG. If abrupt acceleration is detected, it is estimated that the terminal state is the “state in which an impact is being exerted on a terminal.” In contrast, if no abrupt acceleration is detected, the program proceeds to step S803.

At step S803, estimation of the orientation of a terminal and calculation of a change in the terminal orientation are performed. For terminal orientation estimation, the gravity vector vG(t) normalized based on the direction of gravity estimated by the moving state estimation unit 103 is used. Since the gravity vector vG(t) depends on the orientation of the terminal, the orientation of the terminal can be estimated using the gravity vector vG(t). Further, since the thus-calculated terminal orientation is only a momentary orientation estimated at the time point t, changes in the terminal orientation within the time interval wG should also be considered, using information on the time interval wG, as in the case of the acceleration.

At step S804, it is determined whether or not significant acceleration and a change in the terminal orientation are detected within a short time. The “short time” at step S804 is set longer than the time interval set at step S802. For instance, at step S802, the case where significant acceleration is exerted momentarily is assumed, while at step S804, the case where significant acceleration is exerted for about one or two seconds is assumed.

If significant acceleration is detected within a short time and if the orientation of the terminal changes, it is estimated that the terminal state is currently the “Transitioning in holding state.” The “Transitioning in holding state” is, for example, a state in which the terminal is transitioned out of a bag into the hand of the user. In this case, a characteristic acceleration data pattern, wherein great acceleration is exerted on the terminal within a relatively short time and the orientation of the terminal also greatly changes, is obtained. If no great acceleration is detected within a short time or if no great change in the terminal orientation is detected, the program proceeds to step S805.

At step S805, it is determined whether the terminal orientation is substantially horizontal or vertical. If the terminal is maintained substantially vertically or horizontally for more than a preset period of time, it is estimated that the terminal state is the “Contained in bag.” This estimation is based on the fact that when the terminal is contained in a bag, it is usually positioned at a preset position, and hence its orientation does not greatly change, i.e., the orientation is often fixed vertically or horizontally. In contrast, if the terminal orientation is not substantially horizontal or vertical, the program proceeds to step S806.

At step S806, it is determined whether the terminal orientation is oblique. If the terminal orientation is oblique, the program proceeds to step S807, while if the terminal orientation is not oblique, it is estimated that the terminal state is the “N/A.”

At step S807, it is determined whether or not abrupt acceleration was detected more than a preset number of times within a preset period of time. The “preset time period” at step S807 is set longer than the “short time” at step S804. If abrupt acceleration was detected more than the preset number of times within the preset period of time, it is considered that the user is operating the terminal by, for example, pressing a button, and therefore the terminal state is estimated to be the “Being operated.” If abrupt acceleration was not detected more than the preset number of times within the preset period of time, the terminal state is estimated to be the “Held by hand.” This is the termination of the terminal state estimation process.

Referring then to FIG. 9, a detailed description will be given of an example of a reliability calculation model stored in the reliability calculation model storage.

FIG. 9 illustrates a simplified reliability calculation model example, in which one of three degrees (“high,” “medium” and “low”) of reliability is output to each of all combinations of the moving states and terminal states. For instance, the reliability of the combination of the “Held by hand” as a terminal state, and the “boarding state” as a moving state, is set to “low.” This is because when the terminal is held by the hand, vibration due to user hand's shaking is applied to the terminal, and may be mixed up with the vibration applied to the terminal during boarding, whereby the “boarding state” may be output as the moving state estimation result when the actual moving state is not the “boarding state.” Further, the reliability of the combination of the “Contained in bag” as a terminal state and a moving state is set to “high.” This is because in the “Contained in bag,” such a factor as hand shaking, which will adversely affect estimation accuracy, is not liable to be applied to the terminal, and therefore the result of estimation is considered to be close to the actual moving state.

If the terminal state is the “N/A,” correction based on the combination of the moving state and terminal state cannot be performed, and hence the output of the moving state estimation unit 103 must be unconditionally relied upon. In view of this, the reliability is set to “high.”

As described above, the estimation accuracy can be enhanced by considering that the combination of a terminal state and a moving state, which results from, for example, the acceleration due to a factor other than user movement or user hand's shaking and hence contains factors that adversely affect moving state estimation accuracy, may well cause erroneous moving state estimation, and considering, in contrast, that the combination of a terminal state and a moving state, which contains less factors that adversely affect the moving state estimation accuracy, may cause less erroneous moving state estimation.

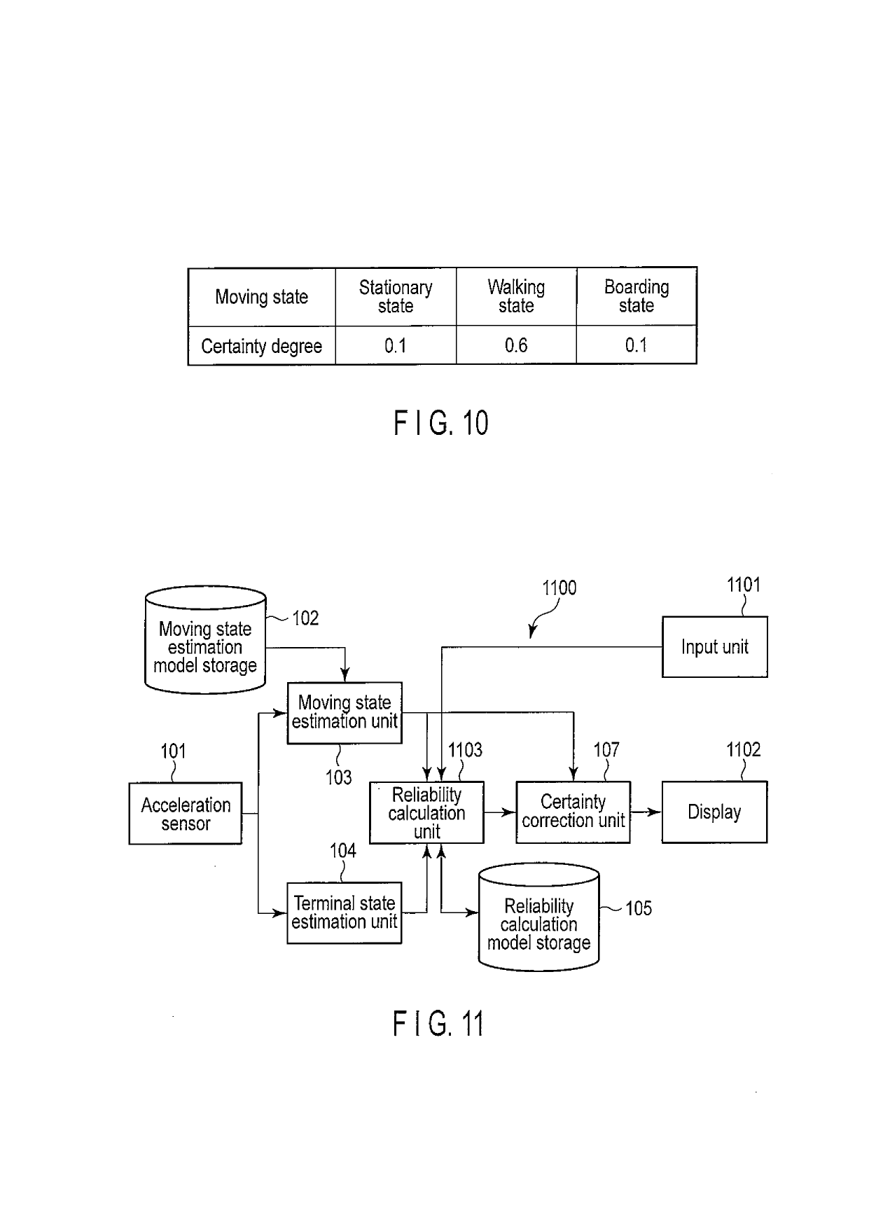

Referring then to FIGS. 2, 9 and 10, operation examples of the certainty correction unit 107 will be described in detail.

A consideration will be given of such a case as shown in FIG. 2, where the degrees of certainty corresponding to the moving state estimation results of the moving state estimation unit 103 are 0.2 for the “stationary state,” 0.6 for the “walking state,” and 0.7 for the “boarding state.” In this case, if the terminal state estimated by the terminal state estimation unit 104 is the “Held by hand,” the degrees of reliability of the combinations of this terminal state and the “stationary state,” “walking state” and “boarding state” are “medium,” “high” and “low,” respectively, with reference to the table of FIG. 9.

In the certainty correction unit 107, it is preset, for example, that if the reliability is “high,” the certainty is directly output, if the reliability is “medium,” the value obtained by multiplying the certainty by 0.5 is output, and if the reliability is “low,” the value obtained by multiplying the certainty by 0.1 is output. Under these conditions, the certainty correction unit 107 calculates degrees of certainty based on the reliability degrees acquired from the reliability calculation unit 106 and the moving states acquired from the moving state estimation unit 103, with the result that values of 0.1, 0.6 and 0.1 are acquired as the final certainty degrees for the “stationary state,” “walking state” and “boarding state,” respectively.

Consequently, the “walking state” of the highest certainty among the three moving states at a certain time point is output the finally estimated moving state. Alternatively, an arbitrary number of moving states with higher certainty degrees, beginning with the moving state with the highest certainty degree, may be output. Yet alternatively, all moving states may be output.

The table shown in FIG. 9 reflects a heuristic method for avoiding the case where when, for example, the terminal is held by the hand, the actual moving state is erroneously estimated as the “boarding state” due to hand shaking. As a result, the final moving state output via the process of the certainty correction unit 107 has its estimation error reduced.

As described above, in the first embodiment, the reliability degrees of moving state estimation results are calculated for the respective combinations of terminal states and moving states, and the moving state certainty degrees are corrected based on the calculated reliability degrees, thereby minimizing moving state estimation errors for a longer time period within a wider range during estimation of the moving state of a user.

Further, in the first embodiment, the moving state estimation results with the certainty degrees corrected are output. As an example method of imparting an advantage to the user using the moving state estimation result, there is a method of controlling the operation of a cellular phone terminal based on the moving state, in which by reducing moving state estimation errors associated with the moving state “boarding state,” the on and off states (e.g., the on and off of manner mode) of the terminal can be automatically and accurately switched.

### Second Embodiment

In the first embodiment, certainty correction is performed only referring to a preset reliability calculation model. However, different moving state estimation results may be acquired between different environments of users. In light of this, the second embodiment is modified such that a user performs certainty degree correction, in addition to the certainty correction based on the reliability calculation model. Thus, in the second embodiment, more appropriate moving state estimation can be performed.

Referring to FIG. 11, a moving state estimation apparatus 1100 according the second embodiment will be described in detail.

As shown, the moving state estimation apparatus 1100 of the second embodiment comprises an input unit 1101 and a display 1102, in addition to the same moving state estimation apparatus as the apparatus 100 of the first embodiment.

The input unit 1101 receives an instruction input by a user, and generates an input signal indicating the instruction of the user. The input unit 1101 is, for example, a touch panel or button, and generates the input signal when the user touches the panel or presses the button. The input unit 1101 is not limited the touch panel or button, but may be another means, such as a microphone. It is sufficient if the input unit can receive an instruction from the user.

The display 1102 receives moving state data from the certainty correlation unit 107 and displays it thereon. If the input unit 1101 is a touch panel, it may be displayed on the display 1102.

A reliability calculation unit 1103 performs substantially the same operation as the reliability calculation unit 106 except that it receives the input signal from the input unit 1101 to update the reliability calculation model based on the input signal.

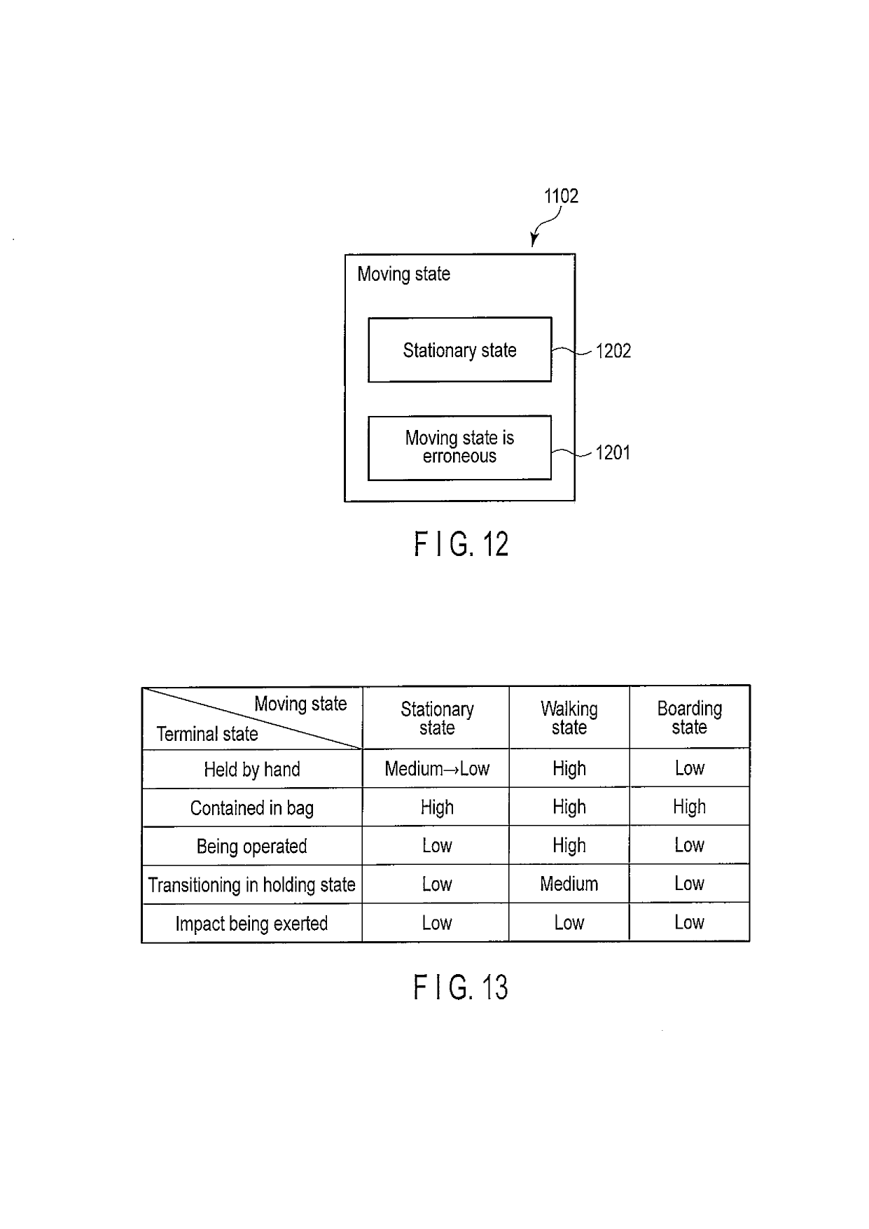

Referring to FIG. 12, an example of the display 1102 will be described in detail.

FIG. 12 shows a user interface incorporated in the terminal, having a touch panel function, and displayed on the screen of the display 1102. The user interface includes a window 1201 for displaying an input by the user, and a window 1202 for displaying an output from the certainty correlation unit 107. Specifically, FIG. 12 shows the “stationary state” as a moving state estimation result, and the window 1201 displays a message “moving state is erroneous.”

An example of correction of the certainty degree based on an instruction from the user will now be described.

Firstly, a consideration will be given to the case where the user takes out a terminal provided with the moving state estimation apparatus of the embodiment, the moving state estimation unit 103 outputs the “stationary state” as the moving state, and the terminal state estimation unit 104 outputs the “Held by the hand” as the terminal state. As shown in FIG. 12, the window 1202 of the display 1102 finally displays the “stationary state” as the output from the certainty correlation unit 107.

At this time, however, if the user is walking and therefore determines that the actual moving state is the “walking state,” they touch the window 1201 displaying the message “moving state is erroneous.”Thus, the user can indicate that the moving state estimation at the current time point is erroneous. More specifically, upon receiving a user instruction, the input unit 1101 generates an input signal and sends the same to the reliability calculation unit 1103.

If it is determined that the moving state estimation result from the certainty correlation unit 107 is erroneous, it is considered that the cause of the error lies in the reliability calculation model stored in the reliability calculation model storage 105. Therefore, the reliability calculation unit 1103 performs, based on the input signal from the input unit 1101, correction for reducing the reliability of the combination of the moving state and the terminal state in the reliability calculation model at the time point at which the input signal was received.

Referring to FIG. 13, a detailed description will be given of a reliability updating example in the reliability calculation model.

In the reliability calculation model of FIG. 13, the reliability of the combination of the “stationary state” as the moving state and the “Held by the hand” as the terminal state is firstly set to “medium.” At this time, if an indication that the current moving state is erroneous is input through the input unit 1101, it is strongly possible that the combination of the “stationary state” as the moving state and the “Held by the hand” as the terminal state, estimated at the current time point, will be erroneous.

Accordingly, the reliability calculation unit 1103 corrects (updates) the reliability calculation model to reduce the reliability of the above combination from “medium” to “low.”

Although in the above example, the reliability calculation model is corrected to reduce the reliability, correction may be performed to increase the reliability if the user determines that the moving state estimation result is correct (right). In this case, the correct moving state estimation result can be learned, which contributes to estimation more suitable for the environment of the user.

If reliability correction is performed again and again, the resultant reliability calculation model may become suitable only for a particular environment. In this case, if moving state estimation is performed in another environment, using the same model, moving state estimation accuracy may be degraded, compared to the case of using the previous reliability calculation model before the correction. To prevent such degradation of the estimation accuracy, the original reliability calculation model (not corrected) may be stored in the reliability calculation model storage 105. If a certain time period elapses, or if a change in environment is detected, or if a change in service area is detected, the corrected (updated) reliability calculation model may be reset to the original model.

The second embodiment constructed as the above can perform moving state estimation more suitable for the user's actual moving state if the user updates, when necessary, the reliability calculation model in accordance with the circumstances.

### Third Embodiment

When the moving state of a user is estimated only using an acceleration sensor, there may be a case where the difference between a moving state of the highest certainty and that of the next highest certainty is almost zero, and hence it is difficult to determine which moving state should be selected. In light of this situation, a moving state estimation apparatus 1400 according to a third embodiment includes another sensor, as well as the acceleration sensor, to thereby further enhance the moving state estimation accuracy.

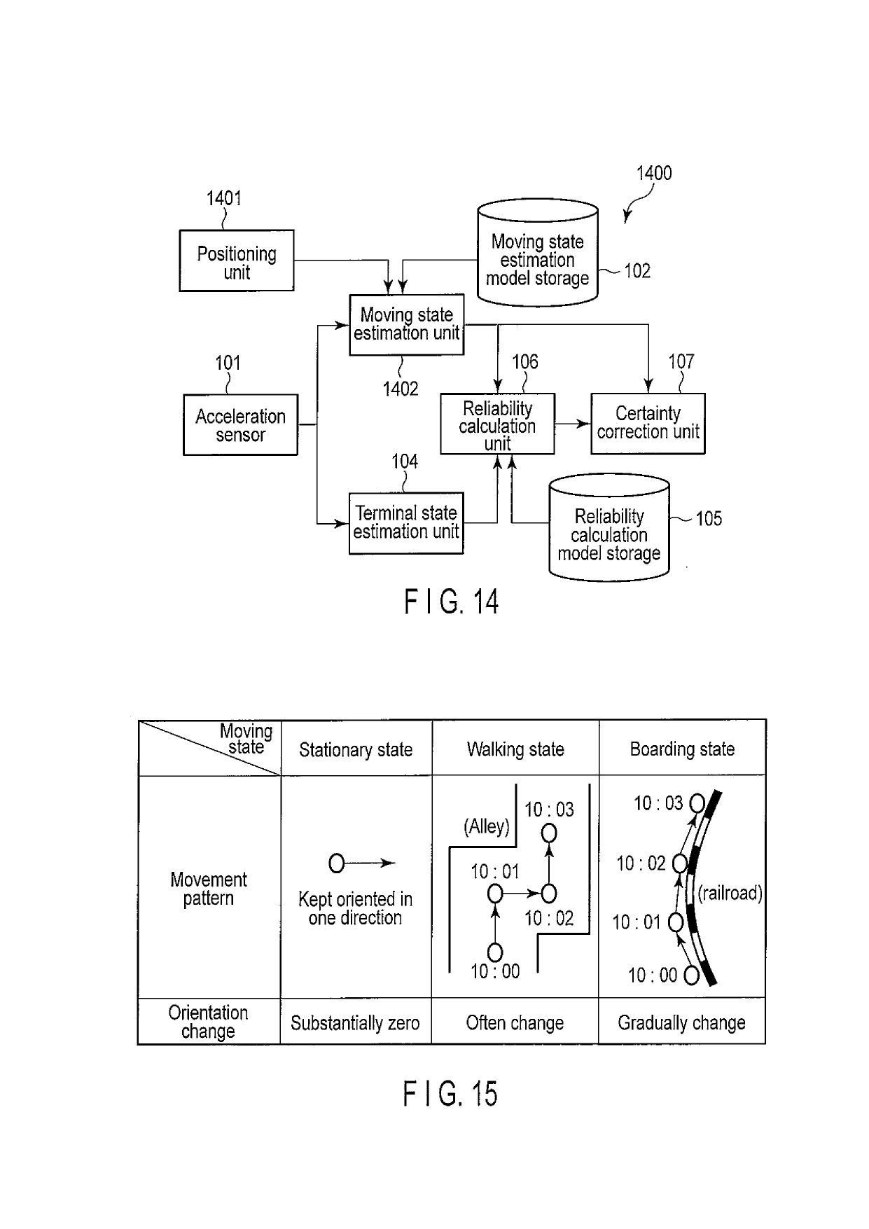

Referring to FIG. 14, the moving state estimation apparatus 1400 of the third embodiment will be described in detail.

The moving state estimation apparatus 1400 of the third embodiment includes a positioning unit 1401, in addition to the same moving state estimation apparatus as the apparatus 100 of the first embodiment.

The positioning unit 1401 is, for example, a GPS or an earth magnetism sensor. When the GPS is used as the positioning unit 1401, it outputs positioning datum indicating the longitude and the latitude of a user as the current location thereof, and the time when the positioning is performed.

A moving state estimation unit 1402 performs substantially the same operation as the moving state estimation unit 103 shown in FIG. 1, but differs therefrom in that the former receives positioning datum from the positioning unit 1401.

By positioning using the GPS, the moving state estimation unit 1402 can detect, based on the positioning datum, that, for example, it has traveled a long distance in a short time when the user is moving by train, whereby it can correct the moving state estimation result based on the positioning data, to enhance the estimation accuracy, i.e., to more reliably determine that the moving state is the “boarding state.”

However, when the GPS is utilized, the consumption of power is increased. This is disadvantageous, in particular, when the moving state estimation apparatus of the embodiment is installed in, for example, a cellular phone terminal, namely, when it is used with a limited power. In this case, the terminal cannot be used for a long time.

To reduce power consumption, in the third embodiment, positioning is not always performed, but is performed using the positioning unit 1401 (GPS) when the certainty of the moving state estimated only based on the acceleration sensor is lower than a threshold, or when the difference in certainty between the moving state of the highest certainty and the moving state of the next highest certainty is smaller than a threshold. For instance, a consideration will be given to the case where the difference in certainty between the moving state “stationary state,” which is estimated to have the highest certainty by the acceleration sensor 101, and the moving state “boarding state,” which is estimated to have the next highest certainty by the acceleration sensor 101, is smaller than a threshold. In this case, if the positioning data of the GPS is utilized and if it is determined, even when the moving state is estimated to be the “stationary state,” that the distance that cannot be traveled in the “stationary state” is being traveled, it can be estimated that the actual moving state is the “boarding state.”

As described above, in the third embodiment, since the GPS is not always driven, the consumption of power can be suppressed, and hence the terminal with a limited power can be used for a relatively long time.

Further, when an earth magnetism sensor is used instead of the GPS, a change in the orientation of the terminal can be detected.

Referring last to FIG. 15, a description will be given of the relationship between the moving state of the terminal and a change in the orientation of the terminal.

As shown in FIG. 15, in the “stationary state,” the terminal is considered to be kept oriented in a certain direction, namely, there is almost no change in orientation. In the “walking state,” the user turns to the left or right at an intersection, enters facilities, etc. Thus, the user changes their directions at frequent intervals. In the “boarding state,” if the user is in a train, gradual changes in direction due to, for example, the curve of a railroad will occur. Utilizing such differences in the rate of change in the orientation of the terminal among the moving states, moving state estimation can be performed.

Namely, there is a case where it is difficult, only from the input of the acceleration sensor 101, to estimate whether the moving state is the “stationary state” or “boarding state.” In this case, if the earth magnetism sensor is used in addition to the acceleration sensor, moving state estimation can be performed such that when almost no change occurs in orientation, this state is estimated to be the “stationary state,” while when a certain rate of change in orientation occurs, the current state is estimated to be the “boarding state.”

In the above-described third embodiment, moving state estimation accuracy can be further enhanced by utilizing a sensor, such as a GPS or earth magnetism sensor, in addition to the acceleration sensor.

The flow charts of the embodiments illustrate methods and systems according to the embodiments. It will be understood that each block of the flowchart illustrations, and combinations of blocks in the flowchart illustrations, can be implemented by computer program instructions. These computer program instructions may be loaded onto a computer or other programmable apparatus to produce a machine, such that the instructions which execute on the computer or other programmable apparatus create means for implementing the functions specified in the flowchart block or blocks. These computer program instructions may also be stored in a computer-readable memory that can direct a computer or other programmable apparatus to function in a particular manner, such that the instruction stored in the computer-readable memory produce an article of manufacture including instruction means which implement the function specified in the flowchart block or blocks. The computer program instructions may also be loaded onto a computer or other programmable apparatus to cause a series of operational steps to be performed on the computer or other programmable apparatus to produce a computer programmable apparatus which provides steps for implementing the functions specified in the flowchart block or blocks.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A moving state estimation apparatus comprising:
a sensor configured to detect at least three-axis acceleration of a terminal as acceleration data
a storage configured to store a moving state estimation model including moving states of a user of the terminal;
a first estimation unit configured to estimate certainty degrees of the moving states based on the acceleration data and the moving state estimation model, the certainty degrees indicating degrees of certainty with which the user may be in the respective moving states;
a second estimation unit configured to calculate orientations of the terminal based on the acceleration data, and to estimate terminal states indicating states of the terminal, based on the orientations of the terminal and the acceleration data;
a calculation unit configured to calculate reliability degrees of the moving states, the reliability degrees indicating degrees with which combinations of the moving states and the terminal states coincide with a combination of an actual moving state of the user and an actual terminal state of the terminal; and
a correction unit configured to correct the certainty degrees in accordance with the reliability degrees, to obtain corrected moving states with the certainty degrees corrected.

2. The apparatus according to claim 1, wherein the terminal states include a first state in which the terminal is held by a hand of the user, a second state in which the terminal is contained in a bag, a third state in which the user is operating the terminal, a fourth state in which an impact is being exerted on the terminal, and a fifth state in which one of the first to fourth states is transitioning to another of the first to fourth states.

3. The apparatus according to claim 1, further comprising:
a display configured to display at least one of the corrected moving states; and
an input unit configured to generate an input signal in accordance with an input by the user, the input indicating whether or not each of the corrected moving states displayed on the display is erroneous,
wherein when the input signal indicates that the each corrected moving state displayed on the display is erroneous, the calculation unit reduces the reliability degree of the combination of the each corrected moving state and the terminal state corresponding thereto.

4. The apparatus according to claim 1, wherein when each of the corrected moving states is lower than the first threshold, and/or when a difference in the certainty degrees between a corrected moving state having a highest certainty degree and a corrected moving state having a next highest certainty degree is not more than the second threshold, the first estimation unit estimates the moving states, using another sensor including at least one of a global positioning system (GPS) and an earth magnetism sensor, in addition to the acceleration sensor.

5. The apparatus according to claim 1, wherein the calculation unit calculates the reliability degrees corresponding to all combinations of the moving states and the terminal states.

6. The apparatus according to claim 1, wherein the actual moving state indicates a moving state which has happened actually, and the actual terminal state indicates a terminal state which has happened actually.

7. A moving state estimation method comprising:
detecting at least three-axis acceleration of a terminal as acceleration data;
storing a moving state estimation model including moving states of a user of the terminal to a storage;
estimating certainty degrees of the moving states based on the acceleration data and the moving state estimation model, the certainty degrees indicating degrees of certainty with which the user may be in the respective moving states;
calculating orientations of the terminal based on the acceleration data, and estimating terminal states indicating states of the terminal, based on the orientations of the terminal and the acceleration data;
calculating reliability degrees of the moving states, the reliability degrees indicating degrees with which combinations of the moving states and the terminal states coincide with a combination of an actual moving state of the user and an actual terminal state of the terminal; and
correcting the certainty degrees in accordance with the reliability degrees, to obtain corrected moving states with the certainty degrees corrected.

8. The method according to claim 7, wherein the terminal states include a first state in which the terminal is held by a hand of the user, a second state in which the terminal is contained in a bag, a third state in which the user is operating the terminal, a fourth state in which an impact is being exerted on the terminal, and a fifth state in which one of the first to fourth states is transitioning to another of the first to fourth states.

9. The method according to claim 7, further comprising:
displaying at least one of the corrected moving states; and
generating an input signal in accordance with an input by the user, the input indicating whether or not each of the corrected moving states displayed on the display is erroneous,
wherein when the input signal indicates that the each corrected moving state displayed on the display is erroneous, the calculating the reliability degrees reduces the reliability degree of the combination of the each corrected moving state and the terminal state corresponding thereto.

10. The method according to claim 7, wherein when each of the corrected moving states is lower than the first threshold, and/or when a difference in the certainty degrees between a corrected moving state having a highest certainty degree and a corrected moving state having a next highest certainty degree is not more than the second threshold, the estimating the certainty degrees estimates the moving states, using another sensor including at least one of a global positioning system (GPS) and an earth magnetism sensor, in addition to the acceleration sensor.

11. The method according to claim 7, wherein the calculating the reliability degrees calculates the reliability degrees corresponding to all combinations of the moving states and the terminal states.

12. The method according to claim 7, wherein the actual moving state indicates a moving state which has happened actually, and the actual terminal state indicates a terminal state which has happened actually.

13. A non-transitory computer readable medium including computer executable instructions, wherein the instructions, when executed by a processor, cause the processor to perform a method comprising:
detecting at least three-axis acceleration of a terminal as acceleration data;
storing a moving state estimation model including moving states of a user of the terminal to a storage;
estimating certainty degrees of the moving states based on the acceleration data and the moving state estimation model, the certainty degrees indicating degrees of certainty with which the user may be in the respective moving states;
calculating orientations of the terminal based on the acceleration data, and estimating terminal states indicating states of the terminal, based on the orientations of the terminal and the acceleration data;
calculating reliability degrees of the moving states, the reliability degrees indicating degrees with which combinations of the moving states and the terminal states coincide with a combination of an actual moving state of the user and an actual terminal state of the terminal; and
correcting the certainty degrees in accordance with the reliability degrees, to obtain corrected moving states with the certainty degrees corrected.

14. The computer readable medium according to claim 13, wherein the terminal states include a first state in which the terminal is held by a hand of the user, a second state in which the terminal is contained in a bag, a third state in which the user is operating the terminal, a fourth state in which an impact is being exerted on the terminal, and a fifth state in which one of the first to fourth states is transitioning to another of the first to fourth states.

15. The computer readable medium according to claim 13, further comprising:
displaying at least one of the corrected moving states; and
generating an input signal in accordance with an input by the user, the input indicating whether or not each of the corrected moving states displayed on the display is erroneous,
wherein when the input signal indicates that the each corrected moving state displayed on the display is erroneous, the calculating the reliability degrees reduces the reliability degree of the combination of the each corrected moving state and the terminal state corresponding thereto.

16. The computer readable medium according to claim 13, wherein when each of the corrected moving states is lower than the first threshold, and/or when a difference in the certainty degrees between a corrected moving state having a highest certainty degree and a corrected moving state having a next highest certainty degree is not more than the second threshold, the estimating the certainty degrees estimates the moving states, using another sensor including at least one of a global positioning system (GPS) and an earth magnetism sensor, in addition to the acceleration sensor.

17. The computer readable medium according to claim 13, wherein the calculating the reliability degrees calculates the reliability degrees corresponding to all combinations of the moving states and the terminal states.

18. The computer readable medium according to claim 13, wherein the actual moving state indicates a moving state which has happened actually, and the actual terminal state indicates a terminal state which has happened actually.
